(19) United States
(12) Patent Application Publication
(10) Pub. No.: US 2024/0327241 A1
(43) Pub. Date: Oct. 3, 2024

(54) Lithium nickel-based composite oxide as a positive electrode active material for rechargeable lithium-ion batteries

(71) Applicant: Umicore, Brussels (BE)

(72) Inventors: KyeongSe SONG, Cheonan (KR); HeeSuk KU, Cheonan (KR); Olesia KARAKULINA, Cheonan (KR); Maxime BLANGERO, Cheonan (KR)

(21) Appl. No.: 18/574,391

(22) PCT Filed: Jun. 24, 2022
(86) PCT No.: PCT/EP2022/067323

§ 371 Date: Dec. 27, 2023

(30) Foreign Application Priority Data
Jun. 28, 2021 (EP) 21182023.8

(51) Int. Cl. C01G 53/00; H01M 10/0525; H01M 10/44

(52) U.S. Cl. CPC C01G 53/50; H01M 10/0525; H01M 10/44; C01P 2004/51; C01P 2004/61; C01P 2006/12; C01P 2006/40; C01P 2006/80; H01M 2220/20

(57) ABSTRACT

The invention relates to a positive electrode active material for suitable for electric vehicle (EV) and hybrid electric vehicle (HEV) applications, wherein said material comprises lithium transition metal-based oxide particles comprising soluble S content and having a high specific surface area.

### TECHNICAL FIELD AND BACKGROUND

The invention relates to a positive electrode active material for suitable for electric vehicle (EV) and hybrid electric vehicle (HEV) applications, wherein said material comprises lithium transition metal-based oxide particles comprising soluble S content and having a high (specific) surface area.

A positive electrode active material is defined as a material which is electrochemically active in a positive electrode. By active material, it must be understood a material capable to capture and release Li ions when subjected to a voltage change over a predetermined period of time.

Positive electrode active materials and methods of manufacturing thereof are known. For example, Example 7 of WO2011/071068A1 discloses washing with Al₂(SO₄)₃ followed by rinsing with water and heating at 600° C. As table 1 of WO2011/071068A1 shows, the specific surface area of example 7 of WO2011/071068A1 is 0.45 m²/g.

However, there is still a need to provide further improved positive electrode active materials.

It is therefore an object of the present invention to provide a positive electrode active material having one or more improved electrochemical properties, such as first charge capacity (DQ1) and capacity fading rate (QF), in an electrochemical cell for example through increased specific surface area weight as measured by BET. In particular, it is an object of the invention to provide a positive electrode active material preferably having an improved first charge capacity (DQ1) of at least 212 mAh/g and capacity fading rate (QF) of at most 20%/100 cycles in the electrochemical cell.

### SUMMARY OF THE INVENTION

This objective is achieved by providing a positive electrode active material suitable for electrochemical cell, wherein the positive electrode active material comprises Li, M′, and oxygen, wherein M′ comprises:
Ni in a content x between 60.0 mol % and 95.0 mol %, relative to M′,
Co in a content y, wherein 0≤y≤40.0 mol %, relative to M′,
Mn in a content z, wherein 0≤z≤70.0 mol %, relative to M′,
element other than Li, O, Ni, Co, Mn, S, B, Zr, and Al in a content a, wherein 0≤a≤2.0 mol %, relative to M′, and,
soluble S in a content b between 0.1 mol % and 0.8 mol %, relative to M′,
B in a content c wherein 0≤c≤2.0 mol %, relative to M′,
Zr in a content d wherein 0≤d≤2.0 mol %, relative to M′,
Al in a content e wherein 0≤e≤2.0 mol %, relative to M′,
wherein x, y, z, a, b, c, d, and e are measured by ICP,
wherein x+y+z+a+b+c+d+e is 100.0 mol %,
   wherein the positive electrode active material has a (specific) surface area between 0.6 m²/g and 1.1 m²/g as determined by BET measurement.

The present invention concerns the following embodiments:

### Embodiment 1

In a first aspect, the present invention concerns positive electrode active material suitable for electrochemical cell, wherein the positive electrode active material comprises Li, M′, and oxygen, wherein M′ comprises:
Ni in a content x between 60.0 mol % and 95.0 mol %, relative to M′,
Co in a content y, wherein 0≤y≤40.0 mol %, relative to M′,
Mn in a content z, wherein 0≤z≤70.0 mol %, relative to M′,
element other than Li, O, Ni, Co, Mn, S, B, Zr, and Al in a content a, wherein 0≤a≤2.0 mol %, relative to M′, and,
soluble S in a content b between 0.1 mol % and 0.8 mol %, relative to M′,
B in a content c wherein 0≤c≤2.0 mol %, relative to M′,
Zr in a content d wherein 0≤d≤2.0 mol %, relative to M′,
Al in a content e wherein 0≤e≤2.0 mol %, relative to M′,
wherein x, y, z, a, b, c, d, and e are measured by ICP,
wherein x+y+z+a+b+c+d+e is 100.0 mol %,
   wherein the positive electrode active material has a (specific) surface area between 0.6 m²/g and 1.1 m²/g as determined by BET measurement.

Preferably, the soluble S content b is ≤0.7 mol %, relative to M′ and more preferably b≤0.6 mol %, relative to M′.

Preferably, the soluble S content b is ≥0.2 mol %, relative to M′ and more preferably ≥0.3 mol %, relative to M′.

Preferably, the Ni content x≥70.0 mol %, relative to M′ and more preferably x≥80.0 mol %, relative to M′ and even more preferably x≥81.0 mol %, relative to M′.

Preferably, the Ni content x≤93.0 mol %, relative to M′ and more preferably x≤91.0 mol %, relative to M′.

Preferably, the Co content y>0 mol %, relative to M′ and more preferably y≥1.0 mol %, relative to M′ and even more preferably y≥5.0 mol %, relative to M′.

Preferably, the Co content y≤30 mol %, relative to M′ and more preferably y≤20.0 mol %, relative to M′ and even more preferably y≤10.0 mol %, relative to M′.

Preferably, the Mn content z>0 mol %, relative to M′ and more preferably z≥1.0 mol %, relative to M′ and even more preferably z≥5.0 mol %, relative to M′.

Preferably, the Mn content z≤60 mol %, relative to M′ and more preferably z≤50.0 mol %, relative to M′, even more preferably z≤40.0 mol %, relative to M′, and most preferably z≤20.0 mol %, relative to M′.

In another embodiment, said Ni in a content x is between 70 mol % and 91 mol % relative to M′, said Co in a content y is between 0.0 mol % and 20.0 mol % relative to M′, and said Mn in a content z is between 0.0 mol % and 20.0 mol % relative to M′.

Preferably, the soluble S has a content b of between 0.2 mol % and 0.7 mol % relative to M′, and more preferably a content b of between 0.3 mol % and 0.6 mol % relative to M′.

The soluble sulfur content is easily determined by an ICP analysis after washing of the positive electrode active material of the invention with water. For example, the soluble sulfur can be determined according to the section A) ICP analysis in the detailed description.

In the framework of the present invention, ppm means parts-per-million for a unit of concentration, expressing 1 ppm=0.0001 wt %.

Moreover, in the framework of the present invention, the term “sulfur” refers to the presence of sulfur atoms or sulfur element in the claimed positive electrode active material.

### Embodiment 2

In a second embodiment, preferably according to the Embodiment 1, wherein the B content c is between 0.01 mol % and 2.0 mol %, relative to M′.

Preferably, the B content c is ≤1.5 mol %, relative to M′ and more preferably c≤1.0 mol %, relative to M′.

### Embodiment 3

In a third embodiment, preferably according to the Embodiment 1 or Embodiment 2, wherein the Zr content d is between 0.01 mol % and 2.0 mol %, relative to M′.

Preferably, the Zr content d is ≤1.0 mol % and more preferably d≤0.5 mol %, relative to M′.

Preferably the Zr content d is ≥0.02 mol % and more preferably d≥0.05 mol %, relative to M′.

Preferably, the Al content e between 0.01 mol % and 2.0 mol %, relative to M′.

Preferably, the Al content e is ≤1.0 mol % and more preferably e≤0.5 mol %, relative to M′.

Preferably the Al content e is ≥0.02 mol % and more preferably e≥0.05 mol %, relative to M′.

Preferably, the element content a is between 0.01 mol % and 2.0 mol %, relative to M′.

Preferably, the element content a is ≤1.0 mol % and more preferably a≤0.5 mol %, relative to M′.

Preferably the element content a is ≥0.02 mol % and more preferably a≥0.05 mol %, relative to M′.

Preferably, the element other than Li, O, Ni, Co, Mn, S, B, Zr, and Al is selected from the group consisting of: Ba, Ca, Cr, Fe, Mg, Mo, Nb, Si, Sr, Ti, Y, V, W and Zn.

### Embodiment 4

In a fourth embodiment, preferably according to the Embodiment 1, said material has a (specific) surface area between 0.65 m²/g and 1.10 m²/g as determined by BET measurement

Preferably, said material has a (specific) surface area of at least 0.70 m²/g, more preferably of at least 0.75 m²/g, and even more preferably of at least 0.80 m²/g.

Preferably, said material has a (specific) surface area of at most 1.05 m²/g, and more preferably of at most 1.00 m²/g.

### Embodiment 5

In a fifth embodiment, according to Embodiment 1 to 2, said material has a secondary particle median size D50 of at least 2 μm, and preferably of at least 3 μm as determined by laser diffraction particle size analysis.

Preferably, said material has a secondary particle median size D50 of at most 15 μm, and preferably of at most 10 μm as determined by laser diffraction particle size analysis.

The present invention concerns a use of the positive electrode active material according to any of the preceding Embodiments 1 to 5 in a battery.

Said battery is a rechargeable lithium-ion battery comprising a cathode, an anode, a separator, and electrolyte. Preferably, the electrolyte is a non-aqueous liquid electrolyte.

The positive electrode active material in this invention is used in the positive electrode.

The present invention also concerns the use of the battery according to present invention in an electric vehicle or in a hybrid electric vehicle.

### Embodiment 6

In a second aspect, the present invention is also inclusive of a process for manufacturing the positive electrode active material, comprising the steps of:
Step 1) mixing a lithium transition metal oxide powder with water to obtain a slurry, filtering, and then drying the slurry to obtain a dried powder,
Step 2) mixing the dried powder with a solution comprising a S-containing compound, wherein the solution comprises S in an amount between 300 ppm to 3000 ppm with respect to the weight of the dried powder to obtain a mixture, and
Step 3) heating the mixture in an oxidizing atmosphere at a temperature between 250° C. and less than 500° C. so as to obtain the positive electrode active material powder.

Preferably Step 1 may be advantageously used to remove impurities such as lithium carbonate and result in a positive electrode material with improved properties. This is because the presence of said lithium compound is undesirable since it can, for instance, generate gas during high temperature storage.

Preferably in Step 1), the solid content in the slurry is at most 80 wt %, and more preferable of at most 70%.

Preferably in Step 1), the lithium transition metal oxide powder used is also typically prepared according to a lithiation process, that is the process wherein a mixture of a transition metal precursor and a lithium source is heated at a temperature preferably of at least 500° C. Typically, the transition metal precursor is prepared by coprecipitation of one or more transition metal sources, such as salts, and preferably sulfates of the M′ elements Ni, Mn and/or Co, in the presence of an alkali compound, such as an alkali hydroxide e.g. sodium hydroxide and/or ammonia.

In one embodiment of Step 1), the lithium transition metal oxide powder comprises Zr as a dopant. Such a lithium transition metal oxide powder may be obtained by adding a Zr containing compound together with the lithium source to the transition metal oxide precursor in the lithiation process to prepare the lithium transition metal oxide. Alternatively, a Zr containing compound may be mixed together with the transition metal oxide precursor prior to the lithiation process.

Preferably, said Zr containing compound comprises zirconium oxide.

The advantage of adding Zr as a dopant is that it improves the electrochemical properties of the positive electrode active material according to the present invention.

Optionally, an element containing compound can also be added as a dopant to the positive electrode material in Step 1). Preferably, said element containing compound is added together with the lithium source to the transition metal oxide precursor in the lithiation process to prepare the lithium transition metal oxide. Alternatively, said element containing compound may be mixed together with the transition metal oxide precursor prior to the lithiation process.

Typically the element of the element containing compound is an element other than Li, O, Ni, Co, Mn, S, B, Zr, and Al. Preferably, said element is selected from the group consisting of: Ba, Ca, Cr, Fe, Mg, Mo, Nb, Si, Sr, Ti, Y, V, W and Zn.

The advantage of adding said element as a dopant is that it, for instance, improves the electrochemical properties of the positive electrode active material according to the present invention.

In Step 2), preferably the solution comprising S-containing compound comprises S in an amount between 500 ppm to 2700 ppm with respect to the weight of the dried powder, more preferably in an amount between 600 ppm to 2800 ppm with respect to the weight of the dried powder and most preferably in an amount between 800 ppm to 2500 ppm with respect to the weight of the dried powder.

Preferably in Step 2), the S-containing compound comprises Al₂(SO₄)₃.

In another embodiment of Step 2), the S-containing compound used may comprise, additionally or alternatively to Al₂(SO₄)₃, sulfuric acid and/or sulfate salts.

In Step 3), preferably said heating temperature is at least 250° C., more preferably at least 280° C., and most preferably at least 300° C.

In Step 3), preferably said heating temperature is at most 450° C., more preferably at most 420° C., and most preferably at most 400° C.

Preferably in Step 3), said heating time is between 1 hour and 20 hours.

### Embodiment 7

In a seventh embodiment, according to Embodiment 6, Step 2) comprises the addition of a B containing compound to the solution, optionally together with the S-containing compound. Preferably, the B containing compound added is in the form of a powder.

Preferably in Step 2), the solution additionally comprises a B compound comprises B in an amount of between 100 ppm to 2000 ppm, more preferably in an amount of between 200 ppm to 1800 ppm and most preferably in an amount of between 500 ppm to 1500 ppm.

Preferably, the B containing compound added to the solution in Step 1) may comprise, but is not limited to, boric acid, boron oxide, and/or lithium boron oxide.

### Embodiment 8

In an eighth embodiment, according to Embodiments 6 to 7), the positive electrode active material obtained in Step 3) is preferably the positive electrode active material of the present invention according to any of the preceding Embodiments 1 to 5.

### DETAILED DESCRIPTION

In the following detailed description, preferred embodiments are described so as to enable the practice of the invention. Although the invention is described with reference to these specific preferred embodiments, it will be understood that the invention is not limited to these preferred embodiments. The invention includes numerous alternatives, modifications and equivalents that are apparent from consideration of the following detailed description.

### A) ICP Analysis

### A1) ICP Measurement

The amount of Li, Ni, Mn, Co, S, B, and Zr in the positive electrode active material powder is measured with the Inductively Coupled Plasma (ICP) method by using an Agillent ICP 720-ES (Agilent Technologies). 2 grams of powder sample is dissolved into 10 ml of high purity hydrochloric acid (at least 37 wt % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 ml mark, followed by complete homogenization. An appropriate amount of solution is taken out by pipette and transferred into a 250 mL volumetric flask for the 2^{nd} dilution, where the volumetric flask is filled with internal standard and 10% hydrochloric acid up to the 250 mL mark and then homogenized. Finally, this 50 mL solution is used for ICP measurement. S amount obtained from this step is labelled as total S, which includes both soluble S and insoluble S amounts.

### A2) Soluble Sulfur Measurement

To investigate the soluble S content in the lithium transition metal-based oxide particles according to the invention, washing and filtering processes are performed. 5 grams of the positive electrode active material powder and 100 grams of ultrapure water are measured out in a beaker. The electrode active material powder is dispersed in the water for 5 minutes at 25° C. using a magnetic stirrer. The dispersion is vacuum filtered, and the dried powder is analyzed by the above ICP measurement to determine the amount of remaining S in the compound. The difference between S amount comprised in the positive electrode material powder before and after washing is defined as the insoluble S in mol %, relative to molar contents of Ni, Mn, and Co.

The amount of soluble sulfur is calculated according to equation 1 below:

Soluble S=S in positive electrode material powder before washing(total S)−S in positive electrode material powder after washing(insoluble S) (equation 1)

wherein all S amounts are measured by ICP, in mol % with respect to the total amount of Ni, Mn, and Co.

### B) Particle Size

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring is applied, and an appropriate surfactant is introduced. D50 is defined as the particle size at 50% of the cumulative volume % distributions obtained from the Malvern Mastersizer 3000 with Hydro MV measurements.

### C) Coin Cell Testing

### C1) Coin Cell Preparation

For the preparation of a positive electrode, a slurry that contains a positive electrode active material powder, conductor (Super P, Timcal), binder (KF≠9305, Kureha)—with a formulation of 96.5:1.5:2.0 by weight—in a solvent (NMP, Mitsubishi) is prepared by a high-speed homogenizer. The homogenized slurry is spread on one side of an aluminum foil using a doctor blade coater with a 170 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1M LiPF₆ in EC/DMC (1:2) is used as electrolyte and is dropped between separator and electrodes. Then, the coin cell is completely sealed to prevent leakage of the electrolyte.

### C2) Testing Method

The testing method is a conventional “constant cut-off voltage” test. The conventional coin cell test in the present invention follows the schedule shown in Table 2. Each cell is cycled at 25° C. using a Toscat-3100 computer-controlled galvanostatic cycling station (from Toyo). The schedule uses a 1 C current definition of 220 mA/g in the 4.3V to 3.0V/Li metal window range. The capacity fading rate (QF) is obtained according to below equation 2.

$$QF ( \% / 100 cycles ) = 100 \times ( 1 - \frac{{DQ}_{34}}{{DQ}_{7}} ) \times \frac{1}{27} \times 100 \qquad ( equation 2 )$$

wherein DQ1 is the discharge capacity at the first cycle and DQ25 is the discharge capacity at the 25th cycle.

TABLE 1
Cycling schedule for Coin cell testing method

| | Charge | | | | Discharge | | | |
|---|---|---|---|---|---|---|---|---|
| | | | | V/Li | | | | V/Li |
| | | End | Rest | metal | | End | Rest | metal |
| Cycle | C Rate | current | (min) | (V) | C Rate | current | (min) | (V) |
| 1 | 0.1 | — | 30 | 4.3 | 0.1 | — | 30 | 3.0 |
| 2 | 0.25 | 0.05 | 10 | 4.3 | 0.20 | — | 10 | 3.0 |
| 3 | 0.25 | 0.05 | 10 | 4.3 | 0.50 | — | 10 | 3.0 |
| 4 | 0.25 | 0.05 | 10 | 4.3 | 1.00 | — | 10 | 3.0 |
| 5 | 0.25 | 0.05 | 10 | 4.3 | 2.00 | — | 10 | 3.0 |
| 6 | 0.25 | 0.05 | 10 | 4.3 | 3.00 | — | 10 | 3.0 |
| 7 | 0.25 | 0.1 | 10 | 4.3 | 0.10 | — | 10 | 3.0 |
| 8 | 0.25 | 0.1 | 10 | 4.3 | 1.00 | — | 10 | 3.0 |
| 9-33 | 0.50 | 0.1 | 10 | 4.3 | 1.00 | — | 10 | 3.0 |
| 34 | 0.25 | 0.1 | 10 | 4.3 | 0.10 | — | 10 | 3.0 |

### D) Specific Surface Area Analysis

The specific surface area (or surface area) of the positive electrode active material is measured with the Brunauer-Emmett-Teller (BET) method by using a Micromeritics Tristar II 3020. A powder sample is heated at 300° C. under a nitrogen (N₂) gas for 1 hour prior to the measurement in order to remove adsorbed species. The dried powder is put into the sample tube. The sample is then de-gassed at 30° C. for 10 minutes. The instrument performs the nitrogen adsorption test at 77 K. By obtaining the nitrogen isothermal absorption/desorption curve, the total specific surface area of the sample in m²/g is derived.

The invention is further illustrated by the following (non-limitative) examples:

### Comparative Example 1

Comparative Example 1 (CEX1) is obtained through a solid-state reaction between a lithium source and a transition metal-based source running as follows:
1) Co-precipitation: a transition metal-based oxidized hydroxide precursor with metal composition of Ni_{0.83}Mn_{0.05}Co_{0.12} is prepared by a co-precipitation process in a large-scale continuous stirred tank reactor (CSTR) with mixed nickel-manganese-cobalt sulfates, sodium hydroxide, and ammonia.
2) First mixing: the transition metal-based oxidized hydroxide precursor and 2000 ppm Zr from ZrO₂ are homogenously mix in an industrial blending equipment to obtain a first mixture.
3) Second mixing: the first mixture from Step 2) and LiOH as a lithium source are homogenously mix with a lithium to metal M′ (Li/M′) ratio of 1.04 in an industrial blending equipment to obtain a second mixture.
4) Heating: the mixture from Step 3) is heated at 765° C. for 12 hours under an oxygen atmosphere followed by crushing, classification, and sieving so as to obtain a heated product.
5) Washing: the heated product from Step 4) is washed with water with powder to water ratio of 1:1 at 15° C. for 10 min. The powder is filtered and dried at 140° C. in vacuum followed by sieving. The product of this process is CEX1 having M′ comprising Ni, Mn, and Co in a ratio Ni:Mn:Co of 0.83:0.05:0.012 as obtained by ICP. CEX1 has a D50 of 10.2 μm.

### Example 1.1

Example 1.1 (EX1.1), is obtained through following steps:
1) Aluminum sulfate solution preparation: 7.01 grams of Al₂(SO₄)_{3.16}H₂O powder is mixed with 30 grams of deionized water.
2) Mixing: 1 kg of CEX1 is mixed with aluminum sulfate solution prepared in Step 1 to obtain a moist mixture.
3) Heating: The mixture obtained from Step 1) is heated at 385° C. for 8 hours under an oxygen atmosphere followed by grinding and sieving so as to obtain EX1.1.

### Example 1.2

Example 1.2 (EX1.2) is prepared according to the same method as EX1.1 except that 11.68 grams of Al₂(SO₄)_{3.16}H₂O powder is used.

### Comparative Example 2

Comparative Example 2 (CEX2) is prepared according to CEX1 except that Step 5) washing is not included. Additionally, 1 kg of the heated powder from step 4) is mixed with aluminum sulfate solution, which is prepared by dissolving 7.01 grams of Al₂(SO₄)_{3.16}H₂O powder into 30 grams of deionized water with respect to the weight of the heated powder. The mixture is re-heated at 385° C. for 8 hours under an oxygen atmosphere followed by grinding and sieving so as to obtain CEX2.

### Example 2.1

Example 2.1 (EX2.1) is prepared according to the same method as EX1 except that Al₂(SO₄)₃·16H₂O powder amount is 5.84 grams, and additionally 2.86 grams H₃BO₃ powder is added to the moist powder obtained from step 1). The mixture is heated at 300° C. for 8 hours under an oxygen atmosphere followed by grinding and sieving so as to obtain EX1.1.

### Example 2.2

Example 2.2 (EX2.2) is prepared according to the same method as EX2.1 except that the heating temperature is 385° C.

TABLE 2
Summary of the composition, (specific) surface area, and the corresponding
electrochemical properties of example and comparative examples.

| | | | | | | | Electrochemical | |
|---|---|---|---|---|---|---|---|---|
| | Composition* (mol %) | | | | | (Specific) | property | |
| | | | | soluble | | surface area | DQ1 | QF %/100 |
| ID | Al | B | S | S | Zr | (m²/g) | (mAh/g) | cycles |
| CEX1 | 0.01 | 0.00 | 0.12 | 0.01 | 0.19 | 1.20 | 211.1 | 21.5 |
| EX1.1 | 0.26 | 0.00 | 0.46 | 0.36 | 0.18 | 0.95 | 212.6 | 8.2 |
| EX1.2 | 0.39 | 0.00 | 0.64 | 0.51 | 0.19 | 0.98 | 214.6 | 15.8 |
| CEX2 | 0.25 | 0.00 | 1.01 | 0.85 | 0.19 | 0.53 | 208.9 | 7.6 |
| EX2.1 | 0.20 | 0.40 | 0.40 | 0.31 | 0.19 | 0.83 | 218.4 | 13.4 |
| EX2.2 | 0.19 | 0.40 | 0.39 | 0.31 | 0.18 | 0.90 | 213.6 | 14.5 |

*Relative to molar contents of Ni, Mn, Co, Al, B, soluble S, and Zr

Table 2 summarizes the composition, (specific) surface area, and the corresponding electrochemical properties of example and comparative examples.

CEX1 is a washed material according to CN111422916A having a surface area of 1.2 m²/g. CEX1 shows DQ1 lower than 212 mAh/g and QF higher than 20%/100 cycles. EX1.1 and EX1.2, having the features of a positive electrode material according to the present invention, result in the material having an improved first charge capacity (DQ1) of at least 212 mAh/g and capacity fading rate (QF) of at most 20%/100 cycles in the electrochemical cell. Furthermore, addition of B in EX2.1 and EX2.2, result in a positive electrode material according to the present invention, with more improved electrochemical properties in comparison with the positive electrode materials of EX1.1 and EX1.2.

In one embodiment, the (specific) surface area of the positive electrode active material according to the invention is decreased by increasing the temperature of step 3) of the method of the present invention.

The lower specific surface area of example 7 of WO2011/071068A1 of 0.45 m²/g is originated from the higher final heating temperature in comparison with the present invention.

1-15. (canceled)

16. A positive electrode active material suitable for lithium-ion rechargeable batteries, wherein the positive electrode active material comprises Li, M′, and oxygen, wherein M′ comprises:
Ni in a content x between 60.0 mol % and 95.0 mol %, relative to M′,
Co in a content y, wherein 0≤y≤40.0 mol %, relative to M′,
Mn in a content z, wherein 0≤z≤70.0 mol %, relative to M′,
element other than Li, O, Ni, Co, Mn, S, B, Zr, and Al in a content a, wherein 0≤ a≤2.0 mol %, relative to M′, and,
soluble S in a content b between 0.1 mol % and 0.8 mol %, relative to M′,
B in a content c wherein 0≤c≤2.0 mol %, relative to M′,
Zr in a content d wherein 0≤d≤2.0 mol %, relative to M′,
Al in a content e wherein 0≤e≤2.0 mol %, relative to M′,
wherein x, y, z, a, b, c, d, and e are measured by ICP,
wherein x+y+z+a+b+c+d+e is 100.0 mol %,
wherein the positive electrode active material has a surface area between 0.6 m²/g and 1.1 m²/g, as determined by BET measurement.

17. A positive electrode active material according to claim 16, wherein the B content c is between 0.01 mol % and 2.0 mol %, relative to M′.

18. A positive electrode active material according to claim 16, wherein the Zr content d is between 0.01 mol % and 2.0 mol %, relative to M′.

19. A positive electrode active material according to claim 16, wherein the soluble S content b is ≤0.7 mol %, relative to M′.

20. A positive electrode active material according to claim 16, wherein the surface area is at most 1.05 m²/g, as determined by BET.

21. A positive active material according to claim 16, wherein the surface area is at least 0.65 m²/g, as determined by BET.

22. A positive electrode active material according to claim 16, wherein the Al content e is between 0.01 mol % and 2.0 mol %, relative to M′.

23. Positive electrode active material according to claim 16, wherein the Ni content x≥ 70.0 mol %, relative to M′.

24. Positive electrode active material according to claim 16, wherein the Co content y is between 0 mol % and 20 mol %, relative to M′; and the Mn content z is between is between 0 mol % and 20 mol %, relative to M′.

25. Positive electrode active material according to claim 16, wherein the secondary particle median size D50 is at least 2.0 μm and at most 15.0 μm, as determined by laser diffraction particle size analysis.

26. A method for the manufacturing of a positive electrode active material according to claim 16,
wherein said method comprises the consecutive steps of:
Step 1) mixing a lithium transition metal oxide powder with water to obtain a slurry, filtering, and then drying said slurry to obtain a dried powder,
Step 2) mixing the dried powder with an aqueous solution comprising Al₂(SO₄)₃, wherein said solution comprises S in an amount between 300 ppm to 3000 ppm with respect to the weight of the dried powder, to obtain a mixture, and
Step 3) heating the mixture in an oxidizing atmosphere at a temperature between 250° C. and less than 500° C. so as to obtain the positive electrode active material powder.

27. The method according to claim 26, wherein in Step 3), the mixture is heated at a temperature of between 250° C. and 450° C.

28. The method according to claim 26, wherein in Step 2), a B containing compound is added to the solution in an amount of B between 100 ppm to 2000 ppm.

29. A battery comprising the positive electrode active material according to claim 16.

30. An electric vehicle or a hybrid electric vehicle comprising the battery of claim 29.
